(19) United States
(12) Patent Application Publication
(10) Pub. No.: US 2019/0319346 A1
(43) Pub. Date: Oct. 17, 2019

(54) CIRCUIT BOARD ANTENNA STRUCTURES AND SYSTEMS

(71) Applicant: Honeywell International Inc., Morris Plains, NJ (US)

(72) Inventor: Michal Pokorny, Brno (CZ)

(21) Appl. No.: 15/953,143

(22) Filed: Apr. 13, 2018

(51) Int. Cl. H01Q 1/38; H01Q 5/378; H01Q 21/06; H01Q 1/22

(52) U.S. Cl. CPC H01Q 1/38; H01Q 1/2291; H01Q 21/061; H01Q 5/378

(57) ABSTRACT

Circuit board antenna structures and systems are described herein. One circuit board antenna structure, includes a circuit board, a u-shaped antenna body having a first elongate portion and a second elongate portion separated by a short portion and arranged such that the first elongate portion is positioned closer to the circuit board, the second elongate portion being longer than the first elongate portion and having a feeding probe extending from the second elongate portion and attached to the circuit board, and the second elongate portion also having a grounding probe extending from the second elongate portion and attached to the circuit board.

### TECHNICAL FIELD

The present disclosure relates generally to circuit board antenna structures and systems.

### BACKGROUND

The design of wirelessly connected devices has several challenges. For example, wirelessly connected devices attempt to satisfy: integrating an increased number of wireless systems, having a minimum overall device size, and having a lowest cost. Considering that each wireless system used requires a dedicated antenna (or multiple antennas in case of diversity systems) antennas are a key element which significantly affects the device cost, size, and wireless connectivity performance.

### BRIEF DESCRIPTION OF THE DRAWINGS

FIG. 1A illustrates an example of a circuit board antenna structure in accordance with an embodiment of the present disclosure.

FIG. 1B illustrates a one quarter wavelength resonance mode on a circuit board antenna structure in accordance with an embodiment of the present disclosure.

FIG. 1C illustrates a one half wavelength resonance mode on a circuit board antenna structure in accordance with an embodiment of the present disclosure.

FIG. 1D illustrates a different one half wavelength resonance mode on a circuit board antenna structure in accordance with an embodiment of the present disclosure.

FIG. 2 illustrates an example of a circuit board antenna structure having a second feeding probe in accordance with an embodiment of the present disclosure.

FIG. 3 illustrates an example of a system having two antenna structures provided accordance with an embodiment of the present disclosure.

FIG. 4 illustrates another example of a system having two antenna structures provided accordance with an embodiment of the present disclosure.

### DETAILED DESCRIPTION

Circuit board antenna structures and systems are described herein. One circuit board antenna structure, includes a circuit board, a u-shaped antenna body having a first elongate portion and a second elongate portion separated by a short portion and arranged such that the first elongate portion is positioned closer to the circuit board, the second elongate portion being longer than the first elongate portion and having a feeding probe extending from the second elongate portion and attached to the circuit board, and the second elongate portion also having a grounding probe extending from the second elongate portion and attached to the circuit board.

The embodiments of the present disclosure described herein represent space-saving and low-cost solutions that provide excellent wireless connectivity performance. The present disclosure represents antenna designs which are capable to be adopted for simultaneous operation of the most popular wireless systems (e.g. Sub-GHz, Wireless Local Area Networks (WLAN), and Bluetooth (BT)).

In the present disclosure, embodiments are provided that have a single physical radiator which provides multiple (e.g., three) independent resonation modes at different frequencies. The ability to use the single radiator structure for simultaneous operation of a multiple wireless system provides extraordinary small overall dimensions of the antenna at excellent radio frequency (RF) performance.

Furthermore, the antenna design allows the feeding probe for all resonation modes to be provided in a single feeding probe, if desired. Alternatively, the feeding probe can be separated such that a fundamental mode (i.e., the lowest frequency) and higher frequency modes can be separated into isolated feeding probes. This feature further simplifies and reduces the cost of the antenna structural components, because there is no need for diplexers to split the signal according to frequency.

Unlike current solutions, the embodiments of the present disclosure can be extended into dual-antenna diversity system with little to no separation distance of the antennas, for example, through use of a signal cancelation line. This can further significantly decrease the dual antenna system dimensions. A complete antenna structure or system according to an embodiment of the present disclosure can be constructed by printed circuit board technology, thus it can be a very inexpensive and robust solution in many applications.

In addition to the above, the embodiments of the present disclosure can provide a variety of other benefits. For example, the antenna structures can have a very small size, (e.g., about a 50% PCB area reduction in comparison with conventional solutions (e.g., straight L or F type antennas). Dual-antenna diversity system type embodiments can be achieved with minimum antenna separation, which further reduces the antenna system size and simplifies circuit board trace routing.

Another benefit is that structures of the present disclosure can be manufactured by conventional inexpensive and robust circuit board manufacturing techniques. Also, the feeding probe of the antenna systems can be variable which enables usage of single circuit board chip solutions or multi-circuit board chip solutions of the front-end radio section with no need for diplexers. Further, the RF performance is at least comparable (for fundamental mode) and better (for higher modes) than conventional solutions.

Cost savings can, for example, come from reduced usage of space on the circuit board and the reduction of components by not having to utilize a diplexer component in case of a multi-circuit board chip solution for a radio front-end.

In the following detailed description, reference is made to the accompanying drawings that form a part hereof. The drawings show by way of illustration how one or more embodiments of the disclosure may be practiced.

These embodiments are described in sufficient detail to enable those of ordinary skill in the art to practice one or more embodiments of this disclosure. It is to be understood that other embodiments may be utilized and that mechanical, electrical, and/or process changes may be made without departing from the scope of the present disclosure.

As will be appreciated, elements shown in the various embodiments herein can be added, exchanged, combined, and/or eliminated so as to provide a number of additional embodiments of the present disclosure. The proportion and the relative scale of the elements provided in the figures are intended to illustrate the embodiments of the present disclosure and should not be taken in a limiting sense.

The figures herein follow a numbering convention in which the first digit or digits correspond to the drawing figure number and the remaining digits identify an element or component in the drawing.

As used herein, “a” or “a number of” something can refer to one or more such things, while “a plurality of” something can refer to more than one such things. For example, “a number of devices” can refer to one or more devices, while “a plurality of devices” can refer to more than one device.

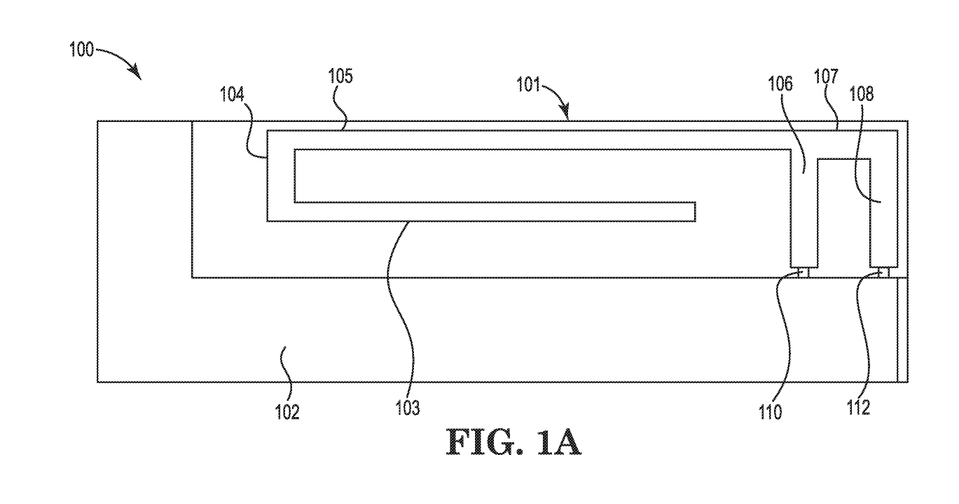

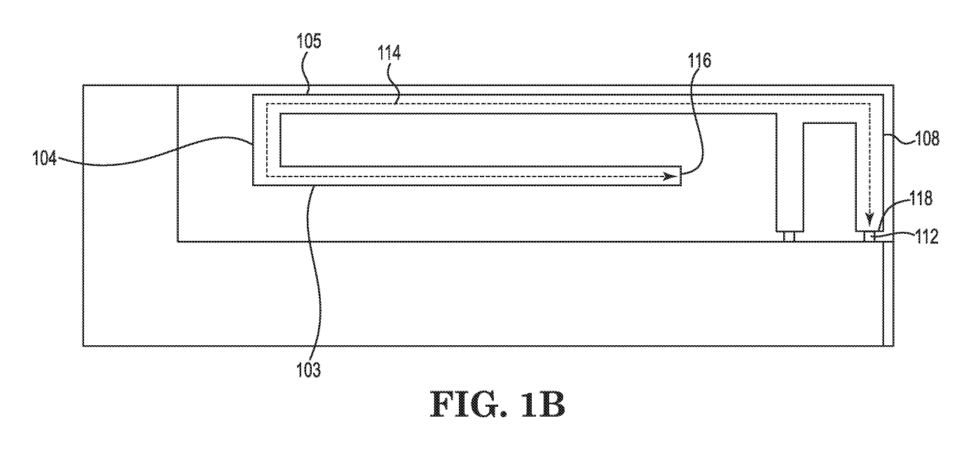

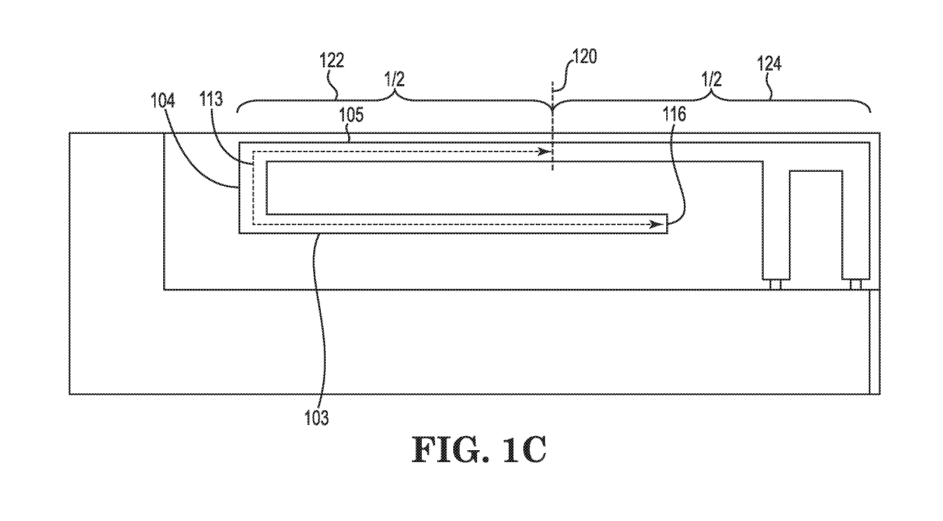

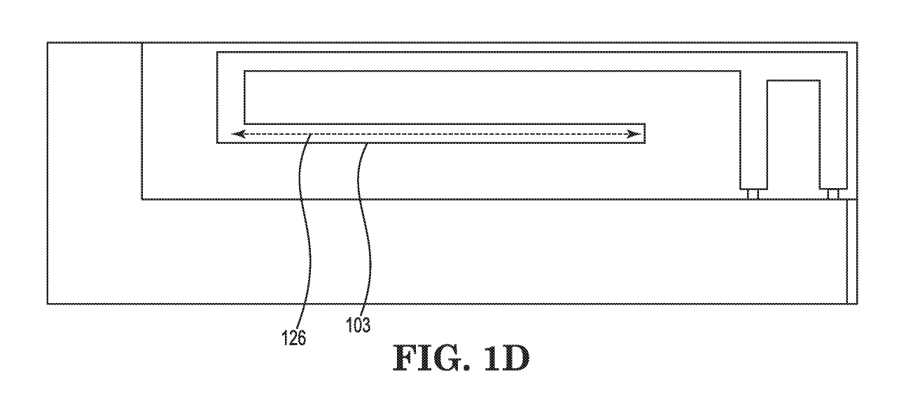

In the embodiment of FIGS. 1A-1D, the antenna resonator structures shown include a multi-mode capability. FIG. 1A illustrates an example of a circuit board antenna structure in accordance with an embodiment of the present disclosure.

In FIG. 1A, the antenna structure 100 includes a circuit board 102 with an antenna body 101 connected thereto. The antenna body includes a first elongate portion 103 and a second elongate portion 105 separated by a short portion 104 and arranged such that the first elongate portion 103 is positioned closer to the circuit board 102.

In the embodiment shown in FIG. 1A, the second elongate portion 105 is longer than the first elongate portion 103 and has a feeding probe 106 extending from the second elongate portion and attached to the circuit board 102 at feeding point 110. The second elongate portion 105 also has a grounding probe 108 extending from the second elongate portion and attached to the circuit board 102 at grounding point 112. FIG. 1A also shows a part 107 of the second elongate portion 105 that spans between the first feeding probe 106 and the grounding probe 108.

This embodiment includes a physical part that is made of a shape that would be similar to a bent conventional F shaped antenna. However, in embodiments of the present disclosure, the antenna includes two connections with circuit board 102, the feeding point 110 and the grounding point 112, and antenna body parts 103, 104, 105 composing the bended structure. In such embodiments, the resonation modes can be tuned independently by, for example, changing the physical length of the antenna body, the bend location, and/or through use of one or more external matching circuits.

Antenna operation frequencies can be tuned by, for example, adjusting particular antenna dimensions to be equal with resonance lengths of the antenna modes. For instance, as shown in FIG. 1B, a lowest operation frequency is given by the resonation length of the antenna fundamental mode.

FIG. 1B illustrates a one quarter wavelength resonance mode on a circuit board antenna structure in accordance with an embodiment of the present disclosure. In the embodiment illustrated in FIG. 1B, the fundamental mode is one quarter wavelength 114. To achieve this mode, a span of the antenna structure between an end of the first elongate portion 116, the short portion 104, the second elongate portion 105, and an end of the grounding probe 118 has a length that constitutes a predefined wavelength resonance mode (e.g., in the case illustrated in FIG. 1B, the fundamental mode that is one quarter wavelength).

FIG. 1C illustrates a one half wavelength resonance mode on a circuit board antenna structure in accordance with an embodiment of the present disclosure. In this embodiment, a mid-operation frequency is given by a resonation length of the antenna at a first higher mode.

As illustrated in FIG. 1C, it is a half wavelength resonance mode. In the illustrated embodiment of FIG. 1C, the half wavelength antenna portion includes a span of the antenna structure between an end 116 of the first elongate portion 105, the short portion 104, and half 122 of the second elongate portion 105 (portion 105 is divided into two halves 122 and 124 at 120) constitutes a one half wavelength resonance mode 113.

FIG. 1D illustrates a different one half wavelength resonance mode on a circuit board antenna structure in accordance with an embodiment of the present disclosure. In this figure, a highest operation frequency is given by resonation length of the antenna in a second higher mode.

As illustrated in FIG. 1D, it is a half-wavelength resonance mode 126. In the illustrated embodiment of FIG. 1D, the half wavelength antenna portion includes a span of the antenna structure between a first end of the first elongate portion 103 and a second end of the first elongate portion constitutes a one half wavelength resonance mode.

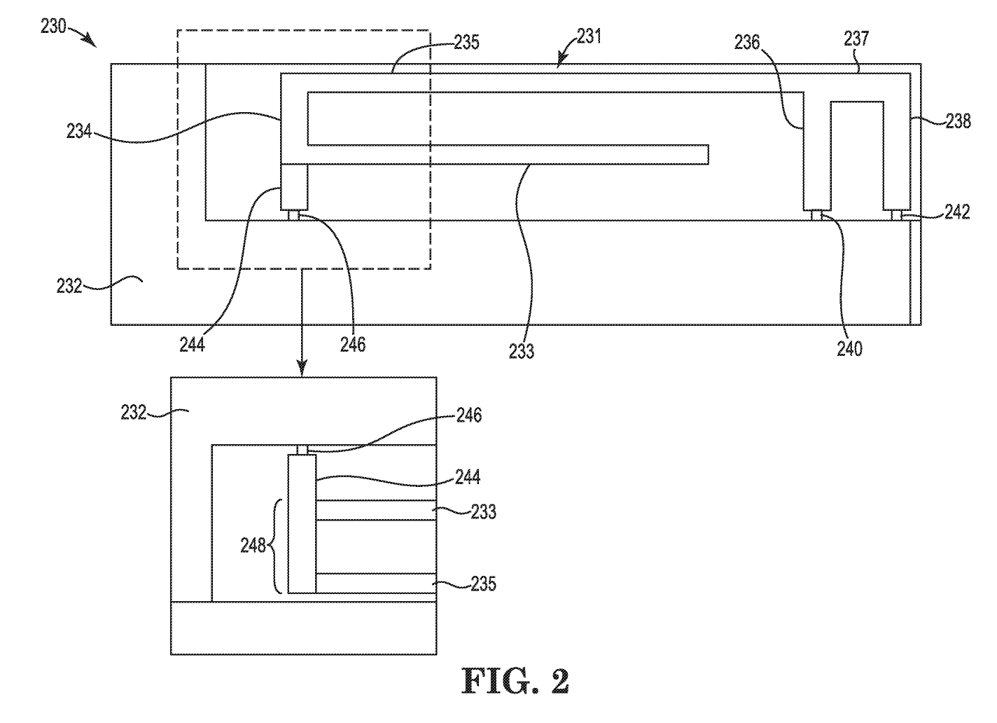

As can be understood from the illustration of FIGS. 1C and 1D, embodiments can have a span of the antenna structure between an end of the first elongate portion 103, the short portion 104, and half of the second elongate portion 105 that constitutes a first one half wavelength resonance mode 113 and a span of the antenna structure between an end of the first elongate portion 103 and a second end of the first elongate portion 103 that constitutes a second one half wavelength resonance mode 126. In such an embodiment, the antenna structure can, therefore, include three resonance wavelengths (i.e., 113, 114, and 126), although the embodiments of the present disclosure are not limited to this number of resonance wavelengths. FIG. 2 illustrates an example of a circuit board antenna structure having a second feeding probe in accordance with an embodiment of the present disclosure. FIG. 2 also includes a dash square area that is shown from the back side below the larger figure. This view is shown in an upside-down orientation where the top in the dashed square above is at the bottom in the solid square below.

The structure 230 of FIG. 2 contains many of the features of the structure of FIG. 1. For example, the antenna body 231 includes a first elongate portion 233 and a second elongate portion 235 separated by a short portion 234.

In the embodiment shown in FIG. 2, the second elongate portion 235 is longer than the first elongate portion 233 and has a first feeding probe 236 extending from the second elongate portion and attached to the circuit board 232 at feeding point 240. The second elongate portion 235 also has a grounding probe 238 extending from the second elongate portion and attached to the circuit board 232 at grounding point 242. FIG. 2 also shows a part 237 of the second elongate portion 235 that spans between the first feeding probe 236 and the grounding point 238.

As shown in FIG. 2, in some embodiments, a second feeding point 246 can be used at the second feeding probe 244 to couple the signal to the antenna structure for higher mode frequencies. In this way, the signals can be physically separated into the fundamental mode at first feeding probe 236 and higher modes at second feeding probe 244 respectively, as shown in FIG. 2.

The second feeding probe can utilize a conductive line section 244 located below (as depicted in FIG. 2) or next to the antenna bend represented by short portion 234. Additionally, in some implementations, the second feeding probe layout overlaps the antenna layout at the bend area and/or along the short portion 234, as shown on the backside view at 248, as shown in FIG. 2. As can be seen from this view, the feeding probe can be a solid piece of material 244 that covers the length of the short portion between first elongate portion 233 and second elongate portion 235.

As discussed herein, the second feeding probe can be a high frequency resonance feeding probe that is connected between the circuit board and the junction between the short portion and the first elongate portion. As shown in FIG. 2, in some embodiments, the high frequency resonance feeding probe can be connected between the circuit board and the junction between the short portion and the first elongate portion and the material forming the second feeding probe extends along at least a part of the short portion.

In such embodiments, the signal coupling can, for example, occur at the overlapped area. In case the second feeding probe needs to be located at the same layer with antenna layout, in some embodiments, the second feeding probe can be located next to the antenna bend 234 or the signal coupling can be achieved using discrete reactive component (e.g. capacitor) connected between antenna body at bend location (234) and the feeding point 246. In this manner, the antenna structure can include a second feeding probe that is coupled between the u-shaped antenna body and the circuit board.

To improve the mutual isolation of the feeding probes 236 and 244, in some embodiments, the frequency selective filter circuits can be used, wherein a low-pass filter circuit is used at feeding point 240 and a high-pass filter circuit is used at second feeding point 246.

If needed, the filter circuit components can be optimized to provide fine antenna impedance matching. In this manner, an excellent isolation and impedance match of the feeding probes at operation frequencies can be achieved.

As discussed herein, in some embodiments, the first feeding probe is a low frequency resonance feeding probe that has a resonance that supports frequencies corresponding to antenna fundamental resonance mode (114 in FIG. 1B). In some such embodiments, as is shown in FIG. 2, the structure includes a high frequency resonance feeding probe (e.g., the second feeding probe) that has a resonance that supports frequencies above antenna fundamental resonance mode (114 in FIG. 1B). Also, as discussed herein, in some embodiments, the low and high frequency resonances can be handled by a single feeding probe.

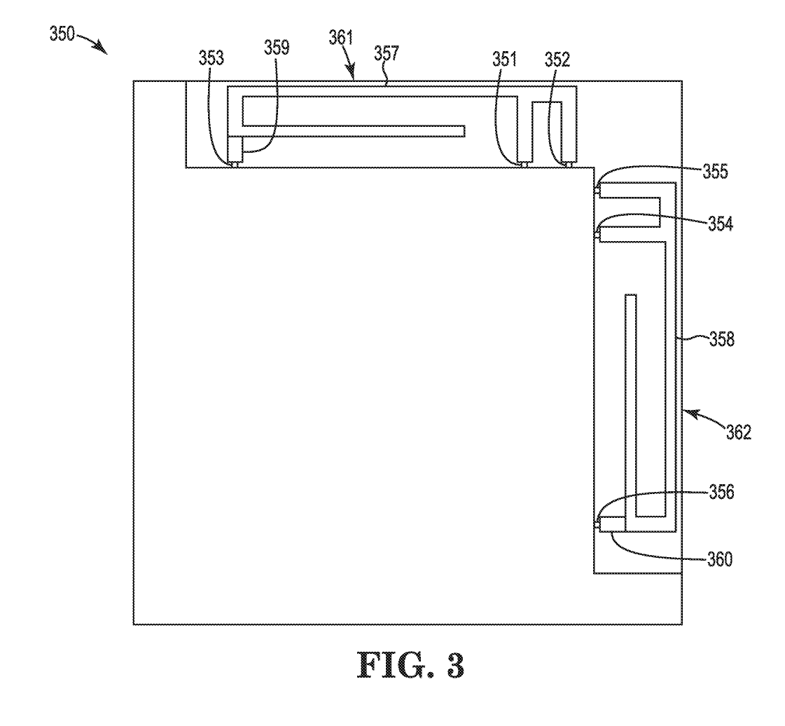

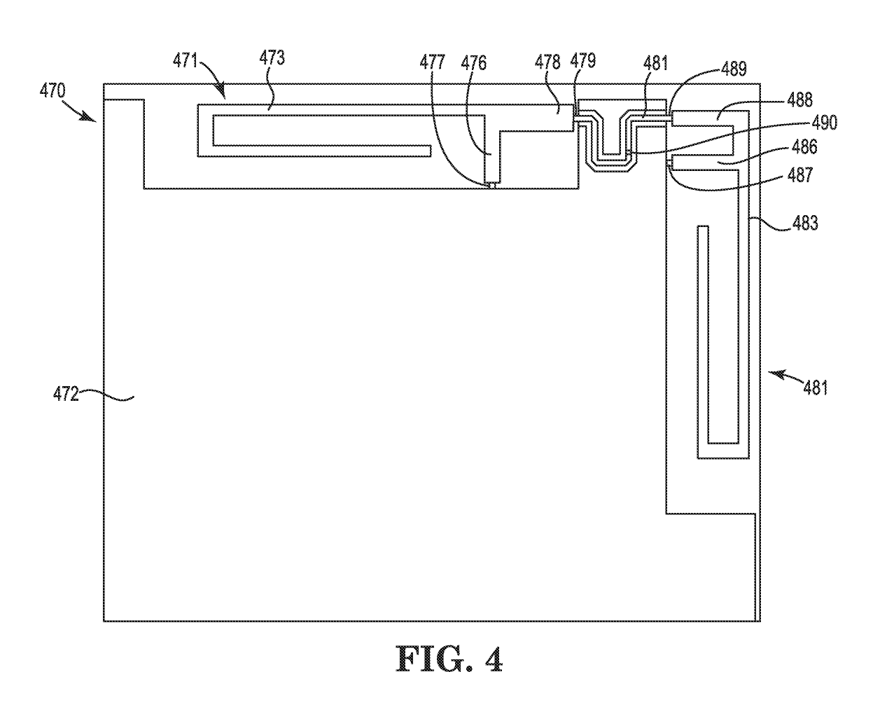

In various embodiments of dual-antenna (diversity) systems, the number of antenna feeding and grounding points are doubled. Examples of dual-antenna systems are shown in FIGS. 3 and 4.

FIG. 3 illustrates an example of a system having two antenna structures provided accordance with an embodiment of the present disclosure. Excellent isolation between feeding points 353 and 356 can be achieved, for example, when antennas are perpendicular to each other and for excellent isolation of feeding points 351 and 354, they also would have needed to be significantly distant (e.g., opposite ends of a mobile device) from each other.

However, such a large antenna distance is not desired, because it can increase the overall device size and can make the circuit board routing more complicated. Due to their unique design, embodiments of the present disclosure can be placed close to each other, as shown in FIG. 3, or can utilize a cancelation line, as shown in FIG. 4, to provide excellent isolation of feeding points 351 and 354 with no need to increase the antenna distance, and thus provide excellent diversity performance.

In the embodiment of FIG. 3, the system 350 includes two antennas constructed similar to that shown in FIG. 2, with each antenna 361/362 having an antenna body 357/358 with feeding probes comprised of elements 359/360, feeding points 353/356, 354/351, and grounding points 352/355. In such an embodiment, the antennas can be located very close to each other due to position of the feeding probes 359/360.

A circuit board antenna system embodiment, such as that shown in FIG. 3, can, for example, include: a circuit board and first and second antenna structures. The first antenna structure can include: a u-shaped antenna body having a first elongate portion and a second elongate portion separated by a short portion and arranged such that the first elongate portion is positioned closer to the circuit board, the second elongate portion being longer than the first elongate portion and having a first feeding probe extending from the second elongate portion and attached to the circuit board, and the second elongate portion also having a second feeding probe extending from the second elongate portion and attached to the circuit board.

Similarly, the second antenna structure can include: a u-shaped antenna body having a first elongate portion and a second elongate portion separated by a short portion and arranged such that the first elongate portion is positioned closer to the circuit board, the second elongate portion being longer than the first elongate portion and having a first feeding probe extending from the second elongate portion and attached to the circuit board, and the second elongate portion also having a second feeding probe extending from the second elongate portion and attached to the circuit board; and wherein at least one of the first and second elongate portions of the first antenna structure is generally perpendicular to at least one of the first and second elongate portions of the second antenna structure.

As used herein, generally perpendicular can be within 15 degrees of perpendicular. By using an embodiment such as this, the signals from the two antennas do not substantially interfere with each other.

In embodiments such as that illustrated in FIG. 3, the second feeding probe of the first antenna forms a ground for the first antenna structure with the circuit board. Additionally, the second feeding probe of the second antenna forms a ground for the second antenna structure with the circuit board.

FIG. 4 illustrates another example of a system having two antenna structures provided accordance with an embodiment of the present disclosure. In this embodiment, a signal cancelation mechanism is employed that allows the two antennas to be placed proximate to each other.

In some embodiments, such as that shown in FIG. 4 and discussed in more detail below, an embodiment can have a cancelation line between the first antenna structure and the second antenna structure to cancel the over air coupled signal between antennas at first feeding points. For example, the cancelation line can be provided by connecting the grounding probe of the first antenna structure to the grounding probe of the second antenna structure.

The cancelation line can provide a conductive signal path between the feeding points on the first and second antenna structures that is in counter-phase to a signal path that is over air between the first and second antenna structures. Such embodiments, having a signal cancelation line, which interconnects grounding point 479 and 489 (in such embodiments, the points are no longer grounded to circuit board 472), can allow the antenna distance to be reduced to a minimum. In some embodiments, the distance needed is only the space required by the physical dimensions of the cancelation line.

In the embodiment of FIG. 4, the system 470 includes two antennas constructed similar to that shown in FIGS. 2 and 3, with each antenna 471/481 having an antenna body 473/483 with feeding probes comprised of elements, 476/486 and feeding points 477/487. However, instead of having grounding points, the embodiment of FIG. 4 has another set of feeding probes including elements 478/488 and feeding points 479/489 that connect to a cancelation line 481.

The cancelation line can be designed in such a way as to provide the conductive signal path between feeding points 477 and 487 in counter-phase to signal path 477-487 over air (i.e., the phase of the conductive path and the over the air path are opposites). Further, the cancelation line can also include a reactive circuit to adjust the phase of signals propagated between the first and second antenna structures, in some embodiments. For instance, the cancelation line can be provided by an arbitrary transmission line or reactive circuit 490 or combination of both. In this manner, the cancelation line can be adjusted to provide more accurate cancelation.

As discussed herein, the embodiments of the present disclosure provide structures and systems that provide comparable or better performance and offer substantial benefits. For example, they use less components, take up less space on a circuit board, handle more resonance frequencies, and at a lower cost, among other benefits.

Although specific embodiments have been illustrated and described herein, those of ordinary skill in the art will appreciate that any arrangement calculated to achieve the same techniques can be substituted for the specific embodiments shown. This disclosure is intended to cover any and all adaptations or variations of various embodiments of the disclosure.

It is to be understood that the above description has been made in an illustrative fashion, and not a restrictive one. Combination of the above embodiments, and other embodiments not specifically described herein will be apparent to those of skill in the art upon reviewing the above description.

The scope of the various embodiments of the disclosure includes any other applications in which the above structures and methods are used. Therefore, the scope of various embodiments of the disclosure should be determined with reference to the appended claims, along with the full range of equivalents to which such claims are entitled.

In the foregoing Detailed Description, various features are grouped together in example embodiments illustrated in the figures for the purpose of streamlining the disclosure. This method of disclosure is not to be interpreted as reflecting an intention that the embodiments of the disclosure require more features than are expressly recited in each claim.

Rather, as the following claims reflect, inventive subject matter lies in less than all features of a single disclosed embodiment. Thus, the following claims are hereby incorporated into the Detailed Description, with each claim standing on its own as a separate embodiment.

1. A circuit board antenna structure, comprising:
a circuit board;
a u-shaped antenna body having a first elongate portion and a second elongate portion separated by a short portion and arranged such that the first elongate portion is positioned closer to the circuit board;
the second elongate portion being longer than the first elongate portion and having a feeding probe extending from the second elongate portion and attached to the circuit board; and
the second elongate portion also having a grounding point extending from the second elongate portion and attached to the circuit board.

2. The circuit board antenna structure of claim 1, wherein the feeding probe is a low frequency resonance feeding probe that has a resonance that supports frequencies corresponding to antenna fundamental resonance mode.

3. The circuit board antenna structure of claim 2, wherein the structure includes a high frequency resonance feeding probe that has a resonance that supports frequencies above antenna fundamental resonance mode.

4. The circuit board antenna structure of claim 1, wherein the feeding probe has a resonance that supports frequencies at or above antenna fundamental resonance mode.

5. The circuit board antenna structure of claim 1, wherein the antenna structure includes a capacitive coupled feeding probe that is located between the u-shaped antenna body and the circuit board.

6. The circuit board antenna structure of claim 1, wherein the feeding probe is a low frequency resonance feeding probe and wherein the structure also includes a high frequency resonance feeding probe.

7. The circuit board antenna structure of claim 6, wherein the low frequency resonance feeding probe includes a low-pass filter.

8. The circuit board antenna structure of claim 6, wherein the high frequency resonance feeding probe includes a high-pass filter.

9. The circuit board antenna structure of claim 6, wherein the high frequency resonance feeding probe is connected between the circuit board and the junction between the short portion and the first elongate portion.

10. The circuit board antenna structure of claim 9, wherein the high frequency resonance feeding probe is connected between the circuit board and the junction between the short portion and the first elongate portion and extends along at least a part of the short portion.

11. A circuit board antenna system, comprising:
a circuit board;
a first antenna structure having:
a u-shaped antenna body having a first elongate portion and a second elongate portion separated by a short portion and arranged such that the first elongate portion is positioned closer to the circuit board;
the second elongate portion being longer than the first elongate portion and having a first feeding probe extending from the second elongate portion and attached to the circuit board; and
the second elongate portion also having a second feeding probe extending from the second elongate portion and attached to the circuit board; and
a second antenna structure having:
a u-shaped antenna body having a first elongate portion and a second elongate portion separated by a short portion and arranged such that the first elongate portion is positioned closer to the circuit board;
the second elongate portion being longer than the first elongate portion and having a first feeding probe extending from the second elongate portion and attached to the circuit board; and
the second elongate portion also having a second feeding probe extending from the second elongate portion and attached to the circuit board; and wherein at least one of the first and second elongate portions of the first antenna structure is generally perpendicular to at least one of the first and second elongate portions of the second antenna structure.

12. The circuit board antenna system of claim 11, wherein the second feeding probe of the first circuit board forms a ground for the first antenna structure with the circuit board.

13. The circuit board antenna system of claim 12, wherein the second feeding probe of the second circuit board forms a ground for the second antenna structure with the circuit board.

14. The circuit board antenna system of claim 11, wherein the system includes a cancelation line between the first antenna structure and the second antenna structure.

15. The circuit board antenna system of claim 14, wherein the cancelation line is provided by connecting the second feeding probe of the first antenna structure to the second feeding probe of the second antenna structure.

16. The circuit board antenna system of claim 14, wherein the cancelation line provides a conductive signal path between the grounding points on the first and second antenna structures that is in counter-phase to a signal path that is over air between the first and second antenna structures.

17. The circuit board antenna system of claim 16, wherein the cancelation line includes a reactive circuit to adjust the phase of signals propagated between the first and second antenna structures.

18. A circuit board antenna structure, comprising:
a circuit board;
a u-shaped antenna body having a first elongate portion and a second elongate portion separated by a short portion and arranged such that the first elongate portion is positioned closer to the circuit board;
the second elongate portion being longer than the first elongate portion and having a feeding probe extending from the second elongate portion and attached to the circuit board; and
the second elongate portion also having a grounding point extending from the second elongate portion and attached to the circuit board, wherein a span of the antenna structure between an end of the first elongate portion, the short portion, the second elongate portion, and an end of the grounding point constitutes a predefined wavelength resonance mode.

17-18. (canceled)

19. The circuit board antenna system of claim 16, wherein the span of the antenna structure between a first end of the first elongate portion and a second end of the first elongate portion constitutes a one half wavelength resonance mode.

20. The printed circuit board antenna system of claim 16, wherein the span of the antenna structure between an end of the first elongate portion, the short portion, and half of the second elongate portion constitutes a first one half wavelength resonance mode and wherein the span of the antenna structure between a first end of the first elongate portion and a second end of the first elongate portion constitutes a second one half wavelength resonance mode.
